(19) United States
(12) Patent Application Publication
(10) Pub. No.: US 2004/0027732 A1
(43) Pub. Date: Feb. 12, 2004

(54) GMR spin valve sensor with ion implanted areas

(76) Inventors: Brian Kelly, Derry (IE); Kevin John Duddy, Derry (IE); Alan Johnston, Derry (IE); William O'Kane, Derry (IE)

Correspondence Address: Seagate Technology LLC, Intellectual Property Department NRW-097, 7801 Computer Avenue South, Bloomington, MN, 55435, US

(21) Appl. No.: 10/273,196

(22) Filed: Oct. 17, 2002

(30) Foreign Application Priority Data
Aug. 8, 2002 (GB) 0218418.2

(51) Int. Cl. G11B 5/39

(52) U.S. Cl. 360/324.1; 29/603.08; 216/66

(57) ABSTRACT

A magnetic read head for use in a magnetic data storage and retrieval system is disclosed. The read head is typically a giant magnetoresistive (GMR) spin valve read sensor with a portion of the GMR spin valve read sensor implanted with ions. The implanted ions improve the GMR sensor's sensitivity to changes in resistance by increasing the resistance of inefficient or ineffective portions of the sensor. The invention is also directed to methods of making GMR read sensors.

### FIELD OF THE INVENTION

The present invention relates generally to a giant magnetoresistive (GMR) read sensor for use in a magnetic read head. In particular, the present invention relates to a giant magnetoresistive read sensor having enhanced electrical response and improved electrical resistance properties.

### BACKGROUND OF THE INVENTION

Giant magnetoresistive (GMR) read sensors are used in magnetic data storage and retrieval systems to detect magnetically-encoded information stored on magnetic data storage media, such as magnetic discs. A time-dependent magnetic field from a magnetic medium directly modulates the resistivity of the GMR read sensor. A change in resistance of the GMR read sensor can be detected by passing a sense current through the GMR read sensor and measuring the voltage across the sensor. The resulting signal can be used to recover encoded information from the magnetic media.

A typical GMR read sensor configuration is a GMR spin valve in which the GMR read sensor is a multi-layered structure formed of a nonmagnetic spacer layer positioned between a ferromagnetic pinned layer and a ferromagnetic free layer. The magnetization of the pinned layer is fixed in a predetermined direction, typically normal to an air bearing surface of the GMR spin valve, while the magnetization of the free layer rotates freely in response to an external magnetic field. The resistance of the GMR spin valve varies as a function of an angle formed between the magnetization direction of the free layer and the magnetization direction of the pinned layer. This multi-layered spin valve configuration allows for a more pronounced magnetoresistive effect, i.e. greater sensitivity and higher total change in resistance, than is possible with prior anisotropic magnetoresistive (AMR) read sensors, which generally consist of a single ferromagnetic layer.

GMR spin valves are commonly formed from sheet materials (or wafers) that contain the various layers described above (and can optionally include additional layers and potentially contain fewer layers). Multiple GMR spin valve sensors can normally be formed from a single sheet or wafer by applying a photoresist and etching away the edges of the sensor using ion-milling techniques. These methods are successful at forming quality GMR spin valve sensors, but they have the drawback that the edges of the sensors are generally not perpendicular, resulting in a tapered sensor that is complete at its center but incomplete at its edges. FIG. 1 shows an example of a GMR spin valve sensor 10 that has a primary GMR sensor region 12 placed on a ½ gap layer 14. The GMR sensor 10 also includes tapered tail regions 16 at the edges of the primary GMR sensor region 12. Tapered tail regions 16 are usually an undesired consequence of the manner in which the sensor 10 is ion milled from a single sheet, and it is very difficult to have a non-tapered (perpendicular) edge without excessively degrading the ½ gap layer 14. These tapered regions 16 usually do not function as a complete GMR spin valve because they lack one or more of the layers identified above. Even though the tapered regions 16 do not function as a GMR spin valve, they can carry some current, which diminishes the overall GMR effect of the spin valve sensor.

Tapered tail region 16 can significantly diminish the sensitivity of the GMR spin valve sensor because it diminishes the overall response of the sensor. The overall response of a GMR spin valve, or its magnetoresistive effect, directly depends upon the GMR ratio (the maximum absolute change in resistance of the GMR spin valve divided by the resistance of the GMR spin valve multiplied by 100%) of the spin valve.

Accordingly, there is a need for an improved GMR spin valve sensor that enhances the GMR ratio. By increasing the GMR ratio, the GMR spin valve will be capable of an increased read sensitivity, thereby allowing for use in storage mediums with greater storage densities.

### BRIEF SUMMARY OF THE INVENTION

The present invention relates generally to a giant magnetoresistive (GMR) spin valve read sensor, methods of making the GMR spin valve read sensor, and magnetic media read heads including the GMR spin valve read sensor of the invention. The GMR spin valve read sensors of the invention are partially implanted with ions, particularly in the tapered edges of the sensor. The implanted ions increase the resistivity of the portions of the GMR sensor in which they have been implanted, and are believed to limit GMR activity by destroying the interfaces between the multiple layers in the GMR sensor.

Typical GMR spin valve sensors have a stack of films that includes a free layer, a pinning layer, a pinned layer positioned between the free layer and the pinning layer, and a spacer layer positioned between the free layer and the pinned layer. The free layer has a rotatable magnetic moment, while the pinned layer has a fixed magnetic moment.

Although these multiple layers work well when they are all intact, the edges of GMR sensors are often defective because they are not uniformly milled away during ion milling production steps. The present invention addresses this problem by implanting ions in those portions of the GMR sensor that contain incomplete layers and thus do not function as a full GMR sensor. The portion of the GMR spin valve read sensor implanted with ions has a higher resistance than areas without the implanted ions. The resulting overall sensor generally has a magnetoresistive ratio of at least 5 percent. However, those portions of the sensor that have been exposed to the ions have a much lower magnetoresistive ratio. GMR sensors made in accordance with the invention typically have at least a portion of the periphery of the giant magnetoresistive spin valve read sensor that has been implanted with ions.

Ions are normally implanted into the sensor using an ion beam, and typical energy levels for the ion beam are greater than 100 KeV. The ion beam is normally applied in an orientation that is perpendicular to an exposed surface of the sensor. The area of ion implantation can be, and typically is, controlled by a photoresist or other masking layer.

Various ions are suitable for use with the invention, and these include without limitation ions selected from the group consisting of nitrogen and phosphorous. Generally the ions are implanted at a density sufficient to increase electrical resistance in the implanted area. In many implementations the ions are implanted at a density of at least 1×10¹⁰ ions per cm² in the implanted surface area.

The invention is also directed to methods for forming a giant magnetoresistive read head for use in a magnetic data storage and retrieval system. Generally the method comprises providing a giant magnetoresistive sensor sheet film and implanting ions in a portion of the magnetoresistive sensor sheet film. Normally a mask is placed over a portion of the sensor sheet film to limit the area in which the ions are implanted. Also, ion milling can be used to further refine the configuration of the GMR sensor.

The above summary of the present invention is not intended to describe each disclosed embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a simplified inline cross section of a prior art GMR spin valve configuration.

FIG. 2 is a simplified inline cross section of a GMR spin valve constructed and arranged in accordance with an implementation of the invention, showing the likely resulting position of the Air Bearing Surface (ABS) after slider processing.

FIG. 3 is a layer diagram of a GMR read sensor in accordance with the present invention.

FIG. 4 is a simplified inline cross section of a GMR spin valve sheet film after application of a resist, showing the likely resulting position of the Air Bearing Surface (ABS) after slider processing.

FIG. 5 is a simplified inline cross section of a GMR spin valve sheet film after ion implantation, showing the likely resulting position of the Air Bearing Surface (ABS) after slider processing.

FIG. 6 is a simplified inline cross section of a GMR spin valve sheet film after ion milling, showing the likely resulting position of the Air Bearing Surface (ABS) after slider processing.

FIG. 7 is a simplified inline cross section of a GMR spin valve sheet film after ion milling and removal of the resist, showing the likely resulting position of the Air Bearing Surface (ABS) after slider processing.

FIG. 8 is a graph of the resistance of GMR spin valve sheet films in which a portion of the sheet films have been ion implanted.

FIG. 9 is a graph of the GMR response of a GMR spin valve sheet film in which the spin valve sheet film has not been ion implanted.

FIG. 10 is a graph of the GMR response of a GMR spin valve sheet film in which a portion of the spin valve sheet film has been ion implanted.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention is directed to a GMR spin valve read sensor and to methods of making a GMR spin valve read sensor, as well as to magnetic media read heads including the GMR spin valve read sensor of the invention. The GMR spin valve read sensors of the invention are ion implanted over a portion of their surface (with the ions penetrating into the sensor), typically areas near their periphery. The ions are generally implanted by a high energy ion beam such that they penetrate portions of the read sensor that would not otherwise function to create a GMR effect but would still conduct electricity.

Typically the GMR spin valve read sensors have a stack of films that includes a free layer, a pinning layer, a pinned layer positioned between the free layer and the pinning layer, and a spacer layer positioned between the free layer and the pinned layer. The implanted ions are believed to increase the resistivity of the portions of the GMR sensor that have been ion implanted, and may also limit GMR activity by destroying the interface between multiple layers in the film. Areas of the various layers of the GMR spin valve read sensor can be incomplete yet they continue to pass a current. Interrupting the current in these incomplete portions of the sensor is beneficial and accomplished by ion implantation.

The portion of the giant magnetoresistive spin valve read sensor that is implanted with ions has a higher resistance than areas without the implanted ions. This increases the measured magneto resistive electrical response because it reduces areas that would not otherwise provide a GMR effect but would conduct electricity. The resulting sensor generally has a magnetoresistive ratio of at least 1 percent, more typically at least about 5 percent, and frequently greater than 10 percent. Those portions of the sensor that have been exposed to the ions have a much lower magnetoresistive ratio, generally less than 5 percent, more commonly less than 1 percent, and even less than 0.1 percent.

The ions are typically implanted using an ion beam. The energy level of the ion beam should be great enough to cause a significant increase in the electrical resistance of the implanted area. The energy level can vary depending upon the atomic weight of the ion being implanted, but in general larger ions can be implanted with lower energies. Smaller ions, such as nitrogen and phosphorous, are often suitable for use with the invention, and such ions are normally delivered at higher energy levels. Typical energy levels for the ion beam are greater than 100 KeV, commonly over about 150 KeV, and approaching about 200 KeV. In some embodiments the ions are applied at energies greater than about 250 KeV.

The electron beam can be applied to the sensor in a fashion such that the beam is at an angle substantially perpendicular to the sensor's primary surface, where the primary surface refers to the surface substantially parallel to the multiple layers in the GMR sensor. Due to the fact that the ions will greatly limit or destroy the GMR effect in the portions where they are implanted, it is desirable that the implanted area be carefully limited, such as by the application of a photoresist mask layer. The mask layer controls which areas of the sensor receive ions.

Various ions are suitable for use with the invention, and including without limitation ions selected from the group consisting of nitrogen and phosphorous. Other ions suitable for use with the invention includes those elements having an atomic mass (AMU) less than that of Phosphorous including, for example, Helium, Boron, Carbon, Oxygen, Flourine and Neon.

Generally the ions are implanted at a density sufficient to diminish the GMR effect in the implanted area, and to also increase the resistance in the implanted area. In many implementations the ions are implanted at a density of at least 1×10¹⁰ ions per cm² in the implanted area; and commonly greater than 1×10¹⁴ or 1×10¹⁵ ions per cm². In some implementations about 5×10¹⁶ or more ions per cm² are applied. Those skilled in the art will appreciate that the increase in resistance and GMR suppression are ion dose dependent.

Another embodiment of the present invention includes a method for forming a giant magnetoresistive read head for use in a magnetic data storage and retrieval system. Generally, the method comprises providing a giant magnetoresistive sensor sheet film and implanting ions in a portion of the magnetoresistive sensor sheet film. Normally a photoresist is deposited on a portion of the sensor sheet film to limit the implanting ions in the portion of the magnetoresistive sensor sheet film not covered by the photoresist. Also, ion milling can be used to further refine the configuration of the GMR sensor.

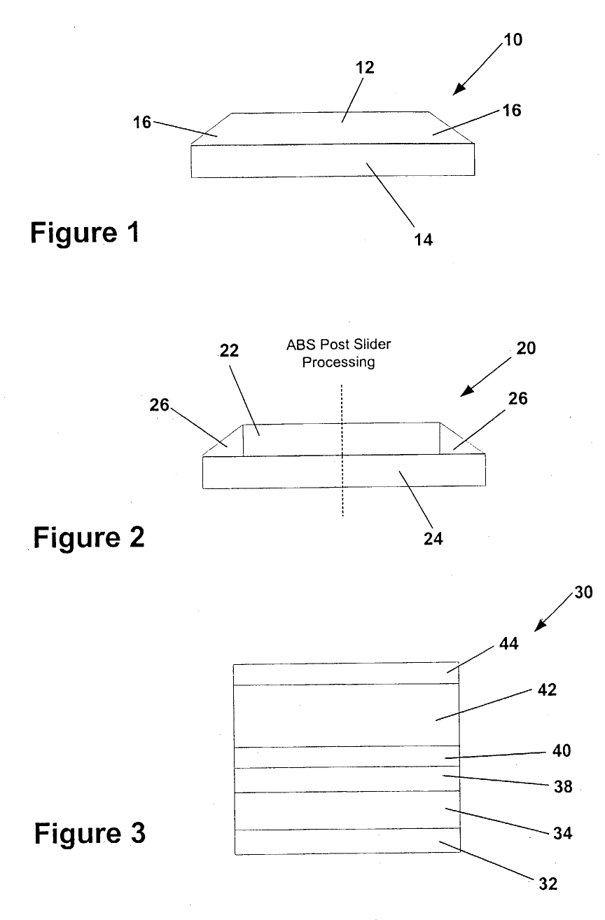

In order to further understand the invention, reference is now made to FIG. 2, which shows a schematic cross-sectional view of a partial constructed (inline) GMR sensor constructed in accordance with one implementation of the invention. The GMR sensor in FIG. 2 is shown sectioned perpendicular to the Air Bearing Surface (ABS). A dotted line is shown in FIGS. 2, and 4-7 extending through a mid portion of the sheet film. This dotted line represents the eventual ABS that results post slider processing. Sensor 20 includes a primary GMR sensor region 22 placed on ½ gap 24, but varies from the prior art sensor shown in FIG. 1 in that it has tail regions 26 that have been implanted with ions in accordance with the present invention. These tail regions 26 have significantly higher resistance than an otherwise identical tail region that has not been implanted with ions. By increasing the resistance of the tail regions 26 the main region 22 of the sensor 20 receives a greater portion of the current and thus displays a more favorable magnetoresistive ratio.

FIG. 3 is an additional diagram of a GMR sensor made in accordance with an implementation of the invention, and is depicted to show the various layers that are present. Specifically, FIG. 3 shows additional layers in the sensor region 22 of FIG. 2 that are not displayed in FIG. 2. Thus, FIG. 3 is a layer diagram of a GMR spin valve 30. GMR spin valve 30 includes substrate 32, free layer 34, spacer layer 38 deposited upon free layer 34, pinned layer 40 deposited onto spacer layer 38, pinning layer 42 deposited upon pinned layer 40, and cap layer 44 deposited upon pinning layer 42. GMR spin valve 30 may also include layers in additional to those shown in FIG. 3.

Typically free layer 34 and pinned layer 40 are each formed of ferromagnetic materials such as NiFe or cobalt-iron (CoFe). Each of free layer 34 and pinned layer 40 may also be formed of multiple layers. Commonly, a bilayer consisting of a NiFe layer and a CoFe layer are used in place of one or both of free layer 34 and pinned layer 40. The magnetization of pinned layer 40 is fixed in a predetermined direction, while the magnetization of free layer 34 rotates freely in response to external magnetic fields. The resistance of GMR spin valve 30 varies as a function of an angle formed between the magnetization of free layer 34 and the magnetization of pinned layer 40. The thickness of free layer 34 is typically in the range of about 10 angstroms to about 500 angstroms, while the thickness of pinned layer 30 is typically in the range of about 10 angstroms to about 100 angstroms. Spacer layer 38 is often formed of a nonmagnetic material such as copper (Cu), or a copper alloy. The thickness of spacer layer 38 is typically in the range of about 20 angstroms to about 35 angstroms.

Pinning layer 42, which is exchange-coupled to pinned layer 40 to fix the magnetization of pinned layer 40 in the predetermined direction, is formed of an antiferromagnetic material such as nickel-manganese (NiMn), nickel-manganese-chromium (NiMnCr), platinum-manganese (PtMn), paladium-platinum-manganese (PdPtMn), chromium-manganese-platinum (CrMnPt), chromium-manganese-copper (CrMnCu), chromium-manganese-paladium (CrMnPd), or platinum-ruthenium-manganese (PtRuMn).

Pinning layer 42 is preferably formed of a material having a relatively high blocking temperature, which is the temperature at which exchange coupling between pinning layer 42 and pinned layer 40 disappears, and a relatively low annealing temperature, which is the temperature at which pinning layer 42 and pinned layer 40 are exchanged coupled during manufacture of GMR spin valve 30. A high blocking temperature will enable better control of the magnetic properties of GMR spin valve 30, and a low anneal temperature will minimize diffusion between layers of GMR spin valve 30. The thickness of pinning layer 34 is typically in the range of about 100 angstroms to about 300 angstroms.

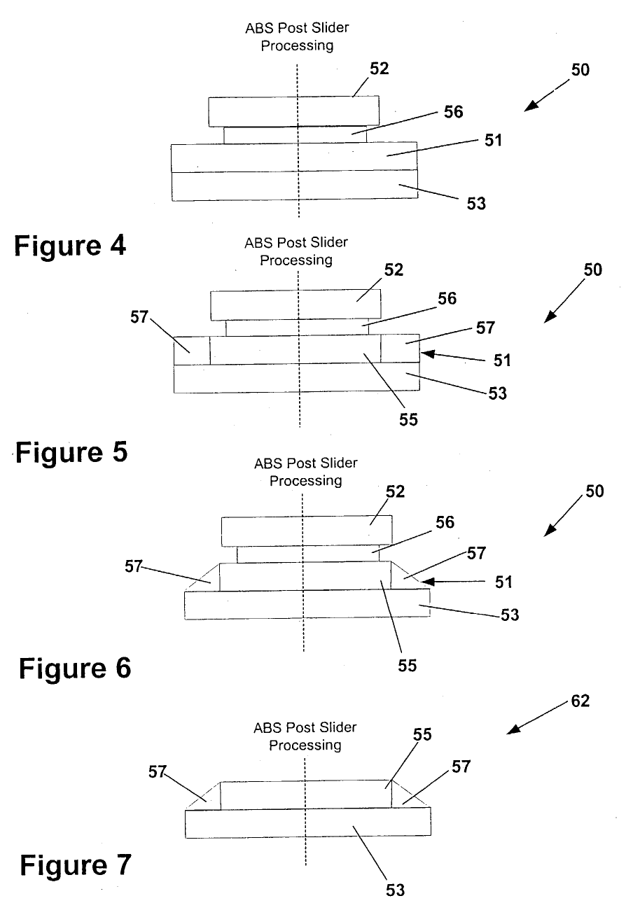

In FIGS. 4 through 7, various steps of forming a GMR spin valve sensor are shown. These figures depict one implementation of how the ion-implanted regions can be created, but various other techniques can be followed without deviating from the invention. FIG. 4 is a simplified cross section of a GMR spin valve sheet film after application of a resist, FIG. 5 is a simplified cross section of a GMR spin valve sheet film after ion implantation, FIG. 6 is a simplified cross section of a GMR spin valve sheet film after ion milling, and FIG. 7 is a simplified cross section of a GMR spin valve sheet film after ion milling and removal of the resist. The sheet films shown in FIGS. 4-7 are shown with a dotted line extending through a mid-portion of the sheet film which represents the likely resulting Air Bearing Surface (ABS), once the sheet film has been lapped or otherwise separated to form the ABS after slider processing.

FIG. 4 shows the GMR spin valve sheet film 50 covered with a resist 52 and a polymethylglutarimide (PMGI) film 56. The resist can be, for example may be a commercially available 248nm chemically amplified resist polymer. The GMR sensor sheet film 50 includes GMR sensor layer 51 and a ½ gap substrate layer 53. FIG. 5 shows the GMR spin valve sheet film 50 of FIG. 4 after ion implantation to perimeter regions 57 not covered by resist 52. The area protected by the resist 52 is not significantly impacted by the ion bombardment and contains the primary sensor region 55. After ion bombardment the excess GMR sensor material is milled away using an ion mill using conventional methods, as shown in FIG. 6. After ion milling the resist 52 and PMGI film 56 are stripped, leaving finished sensor 62 as shown in FIG. 7 that has a ½ gap 53, a primary sensor region 55, and ion implanted perimeter regions 57.

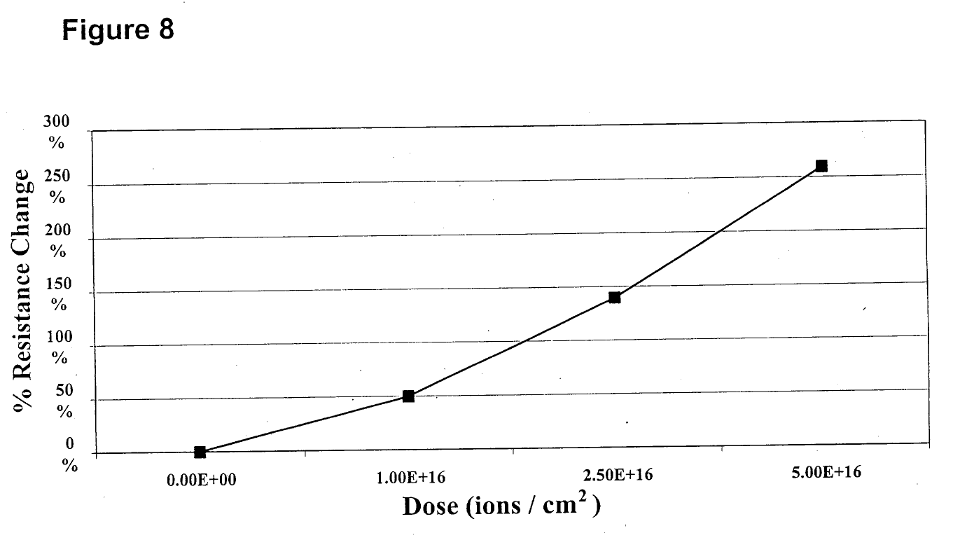

In reference now to FIGS. 8, 9, and 10, physical properties of GMR sheet films made in accordance with implementations of the invention are described. FIG. 8 shows how resistance changes with dose of ions. At moderate ion doses (1.00×10¹⁶) the resistance can increase by over 50 percent, and at elevated ion doses (5.00×10¹⁶) the resistance increases to greater than 250 percent in comparison to material that has not been exposed to an ion beam.

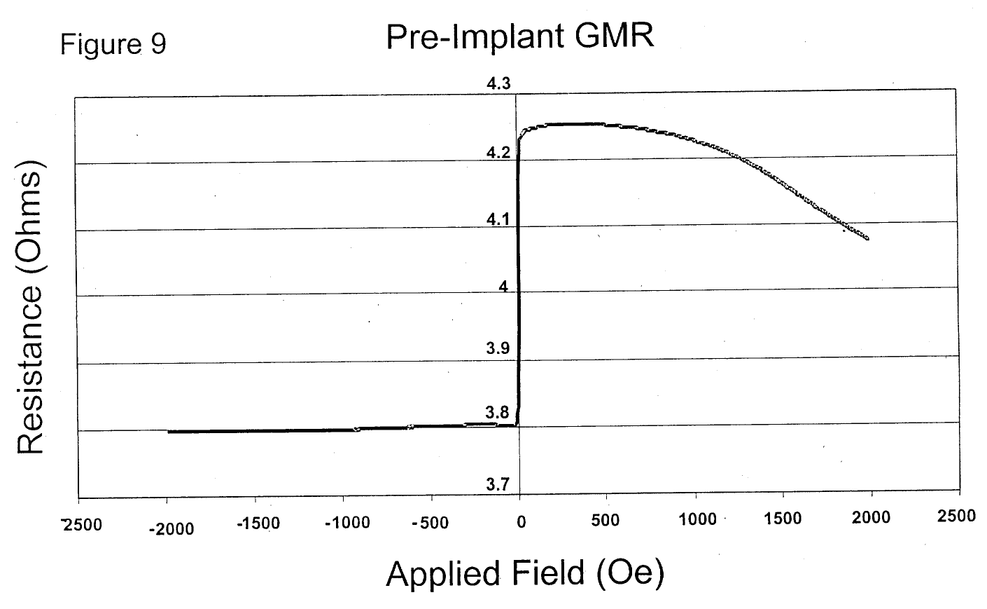

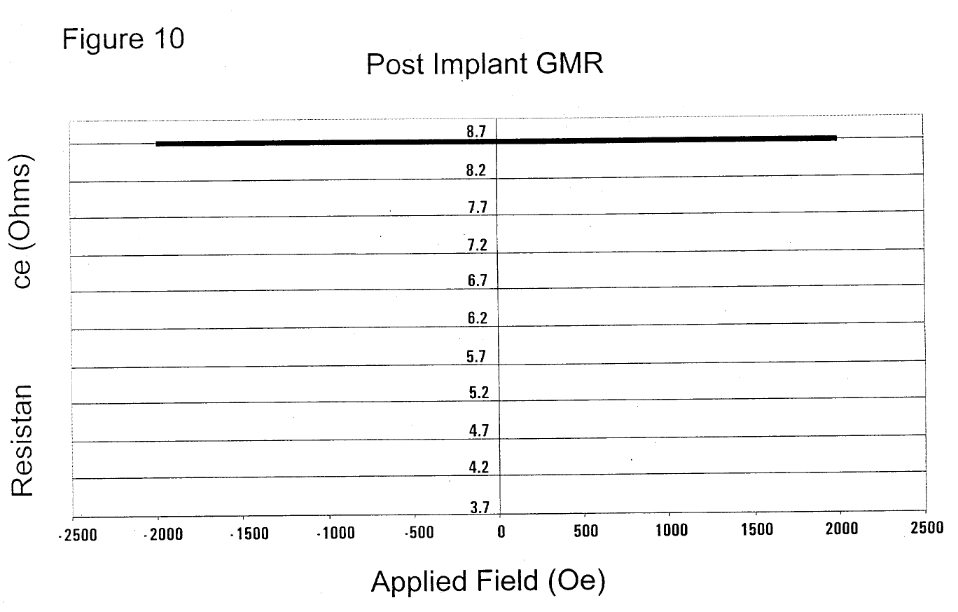

FIGS. 9 and 10 show the comparative GMR response of respective GMR spin valve sheet material that has not been exposed to an ion beam compared to films that have been exposed to a high-energy ion beam. FIGS. 9 and 10 plot the GMR ratio of GMR spin valve material as a function of an applied magnetic field. The GMR ratio of a GMR spin valve is the maximum absolute change in resistance of the GMR spin valve divided by the resistance of the GMR spin valve multiplied by 100%. The material shown in FIG. 9 has not been exposed to a high-energy ion beam and has an Rₘₐₓ of about 4.25 and an Rₘᵢₙ of about 3.80, resulting in a GMR ratio of about 11.98 percent. The material shown in FIG. 10 has been exposed to the ion beam and has an Rₘₐₓ of 8.698 and an Rₘᵢₙ of 8.697, resulting in a GMR ratio of just 0.01 percent. Thus, FIGS. 9 and 10 show how exposure to the electron beam significantly diminishes the GMR effect in the film.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

1. A magnetic read head for use in a magnetic data storage and retrieval system, the magnetic read head comprising:
a giant magnetoresistive spin valve read sensor;
wherein a portion of the giant magnetoresistive spin valve read sensor has been implanted with ions.

2. The magnetic read head of claim 1, wherein the portion of the giant magnetoresistive spin valve read sensor implanted with ions has a higher electrical resistance than areas without the implanted ions.

3. The magnetic read head of claim 1, wherein the sensor has an overall magnetoresistive ratio of at least 5 percent.

4. The magnetic read head of claim 1, wherein at least a portion of a periphery of the giant magnetoresistive spin valve read sensor has been implanted with ions.

5. The magnetic read head of claim 1, wherein:
the giant magnetoresistive spin valve read sensor comprises multiple overlapping layers;
at least some of the multiple layers are incomplete such that they do not contribute to the measure of electron spin; and
wherein the incomplete portions of the multiple layers are at least partially implanted with ions.

6. The magnetic read head of claim 1, wherein the ions have been implanted using an ion beam.

7. The magnetic read head of claim 6, wherein the ion beam has an energy of at least 100 KeV.

8. The magnetic read head of claim 1, wherein the sensor has a primary surface and the ions have been implanted by an ion beam at an angle substantially perpendicular to the sensor's primary surface.

9. The magnetic read head of claim 1, wherein the area of ion implantation has been controlled by a resist.

10. The magnetic read head of claim 1, wherein the ions are selected from the group consisting of nitrogen and phosphorous.

11. The magnetic read head of claim 1, wherein the ions are implanted at a density of at least 1×10¹⁰ ions per cm² in the implanted area.

12. A magnetic read head for use in a magnetic data storage and retrieval system, the magnetic read head comprising:
a multi-layer giant magnetoresistive spin valve read sensor having a periphery of incomplete layers; and
ions implanted into at least a portion of the periphery of the giant magnetoresistive spin valve read sensor;
wherein the giant magnetoresistive spin valve read sensor has a magnetoresistive ratio of at least 5 percent

13. The magnetic read head of claim 12, wherein the ions are selected from the group consisting of nitrogen, phosphorous, Helium, Boron, Carbon, Oxygen, Flourine, Neon, and atoms with an atomic mass less than that of Phosphorous.

14. The magnetic read head of clam 13, wherein the giant magnetoresistive spin valve read sensor has a magnetoresistive ratio of at least 10 percent.

15. A method for forming a giant magnetoresistive read head for use in a magnetic data storage and retrieval system, the method comprising:
providing a giant magnetoresistive sensor sheet film; and
implanting ions in a portion of the magnetoresistive sensor sheet film.

16. The method of claim 15, further comprising:
depositing a photoresist on a portion of the sensor sheet film and implanting ions in the portion of the magnetoresistive sensor sheet film not covered by the photoresist.

17. The method of claim 15, further comprising milling the sensor sheet film to form at least one giant magnetoresistive sensor.

18. The method of claim 15, wherein the ions are selected from the group consisting of Nitrogen, Phosphorus, Helium, Boron, Carbon, Oxygen, Flourine and Neon.

19. The method of claim 15, wherein the ions are added at an energy level of at least 100 KeV.

20. The method of claim 15, wherein the ions are added at a density of at least 1×10¹⁴ ions/cm².

21. The method of claim 15, wherein the giant magnetoresistive spin valve read sensor exhibits a giant magnetoresistive ratio of at least 5 percent.
